(19) United States
(12) Patent Application Publication
(10) Pub. No.: US 2016/0134169 A1
(43) Pub. Date: May 12, 2016

(54) STATOR ASSEMBLY UNIT OF DRIVE MOTOR OF HYBRID VEHICLE

(71) Applicants: Hyundai Motor Company, Seoul (KR); Kia Motors Corporation, Seoul (KR)

(72) Inventors: Dongyeon Han, Seoul (KR); Myung Kyu Jeong, Seoul (KR); Young Jin Seo, Yongin (KR); Hyoungjun Cho, Seoul (KR)

(21) Appl. No.: 14/746,033

(22) Filed: Jun. 22, 2015

(30) Foreign Application Priority Data
Nov. 10, 2014 (KR) 10-2014-0155352

(51) Int. Cl. H02K 5/20

(52) U.S. Cl. CPC H02K 5/20

(57) ABSTRACT

A stator assembly unit of a drive motor includes a stator core fixedly mounted to an inside of a housing of a power transmission element in the drive motor of a hybrid vehicle, and includes a securing member mounted to an inside wall of the housing by press fitting for securing the stator core, where the securing member has an annular shape to form a flow passage as one unit to enable flow of a cooling medium.

### CROSS-REFERENCE TO RELATED APPLICATION

This application claims under 35 U.S.C. §119(a) the benefit of Korean Patent Application No. 10-2014-0155352 filed in the Korean Intellectual Property Office on Nov. 10, 2014, the entire contents of which are incorporated herein by reference.

### BACKGROUND

(a) Field of the Invention

The present invention relates to a hybrid vehicle, more particularly, to a stator assembly unit of a drive motor of the hybrid vehicle, in which a stator core of a drive motor is fixedly secured to an inside of a transmission housing to enable cooling of the stator core.

(b) Description of the Related Art

In general, a hybrid vehicle, also referred to as an eco-friendly vehicle, effectively combines two or more kinds of power sources for driving the vehicle. However, most hybrid vehicles are driven by an engine which obtains torque by burning a fuel (e.g., a fossil fuel such as gasoline) and an electric motor (hereinafter referred to as a “drive motor”) which obtains torque from a battery.

Since the hybrid vehicle uses both mechanical energy of the engine and electrical energy of the battery, not only to optimize use of the engine and the drive motor, but also to recover the energy of the drive motor at the time of braking, fuel consumption may be improved and efficient use of energy is possible.

The drive motor in the hybrid vehicle is coupled to an automatic transmission, which is a drive element of the vehicle. The drive motor is mounted in the transmission housing of the automatic transmission, and the transmission housing has a motor housing fastened thereto for supporting the drive motor and enclosing the transmission housing.

The drive motor has a stator core of a concentrated winding split core type, where the stator core is fixedly secured to the transmission housing, and a rotor is mounted to a motor shaft of the drive motor as one unit therewith.

In particular, the concentrated winding split core type is a type in which the stator core has a plurality of split cores each with a stator coil wound thereon which are connected together.

Since the drive motor generates a large amount of heat by an eddy current at the stator core, it is required to cool down the drive motor for preventing the drive motor from being damaged by the heat to secure consistent stable operation.

Methods for cooling the drive motor, e.g., in the hybrid vehicle which has the motor fixedly secured to an inside of the transmission, include an oil cooling method which uses a transmission oil and a water cooling method which uses cooling water.

In the water cooling method, the stator core is fixedly secured to the transmission housing and a support ring is mounted between the stator core and the transmission housing for cooling the stator core. The support ring is shrinkage fit between the stator core and the transmission housing. A cooling water flow passage is formed between an outside circumferential surface of the support ring and an inside circumferential surface of the transmission housing for making the cooling water flow through a groove formed in the outside circumferential surface of the support ring, and an O-ring is provided thereto for sealing the cooling water flow passage.

According to this arrangement, in the related art, the cooling water flows through the flow passage between the outside circumferential surface of the support ring and the inside circumferential surface of the transmission housing, enabling cooling of the heat generated at the stator core with the cooling water.

However, since the related art stator assembly unit has the O-ring applied between the outside circumferential surface of the support ring and the inside circumferential surface of the transmission housing for sealing the flow passage of the cooling water and the supporting ring for securing the stator core, damage to the O-ring at the time of assembly of the support ring may occur, or it may be degraded by the heat of the stator core, so air tightness of the cooling water flow passage is liable to become poor.

The above information disclosed in this Background section is only for enhancement of understanding of the background of the invention and therefore it may contain information that does not form the prior art that is already known to a person of ordinary skill in the art.

### SUMMARY

The present invention provides a stator assembly unit of a drive motor of a hybrid vehicle having advantages of improved air tightness and cooling performance of a cooling water flow passage for a support ring.

In a preferred embodiment of the present invention, a stator assembly unit of a drive motor of a vehicle, which is an assembly unit of a stator core fixedly mounted to an inside of a housing of a power transmission element in a drive motor of the vehicle (e.g., a hybrid vehicle), may include a securing member mounted to an inside wall of the housing by press fitting for securing the stator core, wherein the securing member has an annular shape with a flow passage formed therein as one unit therewith to enable flow of a cooling medium.

In a preferred embodiment of the present invention, the securing member has a plurality of through holes formed in an outside circumferential surface thereof connected to the flow passage.

In a preferred embodiment of the present invention, the securing member may be manufactured by core-type low pressure casting to have the flow passage formed therein as one unit with the securing member.

A stator assembly unit of a drive motor of a vehicle, which is an assembly unit of a stator core fixedly mounted to an inside of a housing of a power transmission element in a drive motor of the vehicle (e.g., a hybrid vehicle), may include a securing member mounted to an inside wall of the housing by press fitting for securing the stator core, wherein the securing member has an annular shape to include an outer ring for supporting the housing and an inner ring for supporting the stator core, and the inner ring and the outer ring are joined together to form a flow passage between the inner ring and the outer ring to enable flow of a cooling medium.

In a preferred embodiment of the present invention, the inner ring may have at least one first cooling channel formed in the outside circumferential surface thereof, and the outer ring may have a second cooling channel formed in the inside circumferential surface thereof corresponding to the first cooling channel.

In a preferred embodiment of the present invention, the cooling water flow passage may be formed as the first and second cooling channels are put together at the time the inner ring and the outer ring are joined.

In a preferred embodiment of the present invention, the outer ring has a plurality of through holes formed therein connected to the flow passage.

In a preferred embodiment of the present invention, the inner ring and the outer ring are formed of different materials.

In a preferred embodiment of the present invention the inner ring is formed of a carbon steel and the outer ring is formed of aluminum.

In a preferred embodiment of the present invention, the inner ring and the outer ring have joining surfaces thereof that are fusion welded to each other to form one unit.

In a preferred embodiment of the present invention, the inner ring and the outer ring are joined to each other by projection welding.

In a preferred embodiment of the present invention, since the cooling water flow passage is formed in the securing member as the support ring as one unit therewith, dispensing with the O-ring in the related art, a number of components used for the stator assembly unit of the drive motor may be reduced, and a manufacturing cost of the stator assembly unit of the drive motor may be saved.

Moreover, the elimination of the O-ring in the preferred embodiment of the present invention prevents the cooling water flow passage from having poor air tightness caused by damage and degradation of the O-ring, and further improves the cooling performance of the stator core.

Furthermore, in another preferred embodiment of the present invention, the formation of the outer ring and the inner ring of the securing member of different materials reduces weight of an entire assembly structure of the drive motor.

A stator assembly unit for a hybrid vehicle may include: a stator core fixedly mounted to an inside of a housing of a power transmission element in a drive motor of the hybrid vehicle; and a securing member mounted to an inside wall of the housing by press fitting for securing the stator core, wherein the securing member has an annular shape with a flow passage formed in the securing member as one unit to enable flow of a cooling medium.

A stator assembly unit for a hybrid vehicle, may include: a stator core fixedly mounted to an inside of a housing of a power transmission element in a drive motor of the hybrid vehicle; and a securing member mounted to an inside wall of the housing by press fitting for securing the stator core, wherein the securing member has an annular shape with an outer ring for supporting the housing and an inner ring for supporting the stator core, and the inner ring and the outer ring are joined together to form a flow passage between the inner ring and the outer ring to enable flow of a cooling medium.

### BRIEF DESCRIPTION OF THE DRAWINGS

The attached drawings illustrate preferred embodiments of the present invention, and are provided for describing the present invention in more detail, but are not for limiting technical aspects of the present invention.

FIG. 1 schematically illustrates a section of a stator assembly unit of a drive motor of a hybrid vehicle in accordance with a preferred embodiment of the present invention.

FIG. 2 illustrates a perspective view of a securing member applied to the stator assembly unit of FIG. 1.

FIG. 3 illustrates a section of the securing member of FIG. 2.

FIG. 4 schematically illustrates a section of a stator assembly unit of a drive motor of a hybrid vehicle in accordance with another preferred embodiment of the present invention.

FIG. 5 illustrates a perspective view of a securing member applied to the stator assembly unit of FIG. 4.

FIG. 6 illustrates a section of the securing member of FIG. 5.

### DETAILED DESCRIPTION OF THE EMBODIMENTS

The present invention will be described more fully hereinafter with reference to the accompanying drawings, such that persons in this field of art can easily carry it out. However, the present invention may be embodied in different modes, and is not limited to the description of embodiments made herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Parts not relevant to the present invention will be omitted for describing the present invention clearly, and throughout the specification, identical or similar parts will be given the same reference numbers.

Since sizes and thicknesses of elements are shown at will for convenience of description, the present invention is not limited to the drawings without fail, but the thicknesses are enlarged for clearly expressing different parts and regions.

Further, although terms including ordinal numbers, such as first or second, can be used for describing various elements, the elements are not confined by the terms, and are only used for making one element distinctive from other elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

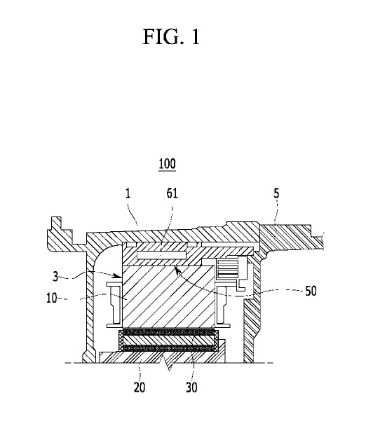

FIG. 1 schematically illustrates a section of a stator assembly unit of a drive motor of a hybrid vehicle in accordance with a preferred embodiment of the present invention.

Referring to FIG. 1, the stator assembly unit in accordance with a preferred embodiment of the present invention may be applied to a drive motor 3 of a hybrid vehicle fixedly secured to a power transmission element in the hybrid vehicle, and as an example, to an inside of a transmission housing 1 of an automatic transmission.

In this case, the transmission housing 1 has a motor housing 5 fastened thereto for supporting the drive motor 3 and enclosing the transmission housing 1.

The drive motor 3 applied to the preferred embodiment of the present invention may include a Permanent Magnet Synchronous Motor (PMSM) or a Wound Rotor Synchronous Motor (WRSM).

The drive motor 3 includes a stator core 10 fixedly mounted to an inside of the transmission housing 1 for generating a magnetic flux, and a rotor core 30 arranged with a fixed air gap to the stator core 10 for rotating centered on a rotating shaft 20 as a drive shaft.

For an example, the drive motor 3 may be applied to an inner-rotor type of synchronous motor having the rotor core 30 arranged inside of the stator core 10. The stator core 10 may be of a concentrated winding split core type which has a plurality of split cores each with a stator coil (not shown) wound thereon.

The stator assembly unit 100 of a drive motor of a hybrid vehicle in accordance with a preferred embodiment of the present invention has a structure in which the stator core 10 of the drive motor 3 is fixedly secured to an inside of the transmission housing 1 and is cooled with a cooling medium (for example, cooling water).

In particular, in the preferred embodiment of the present invention, the stator assembly unit 100 of the drive motor 3 is provided for improving air tightness of a cooling water flow passage and cooling performance on the stator core 10. The stator assembly unit 100 preferably includes a securing member 50 mounted to an inside wall surface of the transmission housing 1.

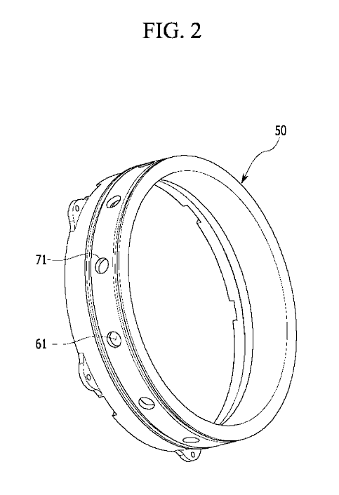

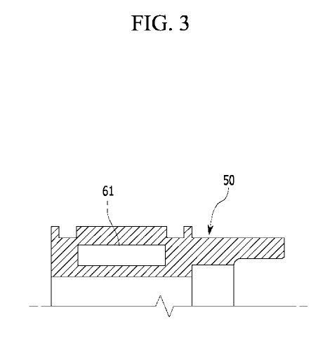

FIG. 2 illustrates a perspective view of the securing member 50, and FIG. 3 illustrates a sectional view of FIG. 2.

Referring to FIGS. 1 to 3, the securing member 50 is provided for supporting and securing the stator core 10 of the drive motor 3 within the transmission housing 1 as well as cooling heat generated at the stator core 10 with the cooling water by a water cooling method.

The securing member 50 may be an annular support ring made of stainless steel having a similar thermal expansion coefficient to that of the stator core 10.

The securing member 50 is mounted to an inside wall surface of the transmission housing 1 and fixedly supported by the motor housing 5 as described above. In this case, the stator core 10 of the drive motor 3 may be placed inside of the securing member 50 with pressure and heat to be shrinkage fit to an inside circumferential surface of the securing member 50 and fixedly secured thereto.

Accordingly, in the preferred embodiment of the present invention, since the stator core 10 of the drive motor 3 is placed inside of the securing member 50 having a similar thermal expansion coefficient to that of the stator core 10 with shrinkage fitting, even if a temperature of the stator core 10 is increased at the time of operation of the drive motor 3 to make the stator core 10 thermally expand, assembly stability of the stator core 10 may be ensured and operation noise and vibration of the drive motor 3 may be reduced.

In the meantime, in the preferred embodiment of the present invention, the securing member 50 has a cooling water flow passage 61 formed therein for allowing flow of the cooling water therethrough as a cooling medium to cool the stator core 10 from outside of the stator core 10.

According to the present invention, as distinguished from the related art in which the cooling water flow passage is formed between the outside circumferential surface of the support ring and the inside circumferential surface of the transmission housing 1, the cooling water flow passage 61 of the present invention may be formed in the securing member 50 as one unit therewith.

In this case, the securing member 50 is manufactured by core-type low pressure casting to form the cooling water flow passage 61 therein as one unit therewith. In particular, the cooling water flow passage 61 may be formed as an annular inside space in the annular body of the securing member 50 in the low pressure casting of the annular securing member 50.

The securing member 50 has a plurality of through holes 71 formed in an outside circumferential surface thereof connected to the cooling water flow passage 61. The through holes 71 are formed at fixed intervals along the outside circumferential surface of the securing member 50 in a circumferential direction of the securing member 50.

For example, the through holes 71 may be formed as a core hole for forming the cooling water flow passage 61 in the securing member 50, or as a cooling water in/out hole for introduction and discharge of the cooling water. Moreover, the through holes 71 may be formed as connection holes for bringing the cooling water flowing along the cooling water flow passage 61 into contact with the inside wall surface of the transmission housing 1.

Therefore, according to the stator assembly unit 100 of a drive motor of a hybrid vehicle in accordance with a preferred embodiment of the present invention, by mounting the securing member 50 to the inside wall surface of the transmission housing 1 by press fitting and shrinkage fitting the stator core 10 of the drive motor 3 to the inside circumferential surface of the securing member 50, the stator core 10 may be strongly supported and secured in the transmission housing 1 through the securing member 50.

In addition, in the preferred embodiment of the present invention, as the cooling water flow passage 61 is formed in the securing member 50 as one unit therewith for flow of the cooling water in the securing member 50, the cooling water flowing through the cooling water flow passage 61 may cool down the heat generated at the stator core 10.

In the preferred embodiment of the present invention as described herein, as distinguished from the related art in which the cooling water flow passage is formed between the outside circumferential surface of the support ring and the inside circumferential surface of the transmission housing with a groove provided in the outside circumferential surface of the support ring for flow of the cooling water, and in which the cooling water flow passage is tightly sealed with the O-ring, the cooling water flow passage 61 of the present invention is formed in the securing member 50 as the support ring as one unit therewith.

Thus, in the preferred embodiment of the present invention, since the cooling water flow passage 61 is formed in the securing member 50 as the support ring as one unit therewith, dispensing with the O-ring in the related art, a number of components used for the stator assembly unit of the drive motor may be reduced, and a manufacturing cost of the stator assembly unit of the drive motor 3 may be saved.

Further, the elimination of the O-ring in the preferred embodiment of the present invention prevents the cooling water flow passage from having poor air tightness caused by damage and degradation of the O-ring, and further improves the cooling performance of the stator core 10.

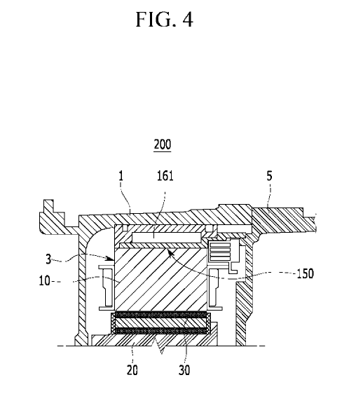

FIG. 4 schematically illustrates a section of a stator assembly unit of a drive motor of a hybrid vehicle in accordance with another preferred embodiment of the present invention.

Referring to FIG. 4, the stator assembly unit 200 has a securing member 150 preferably made of multiple, different materials.

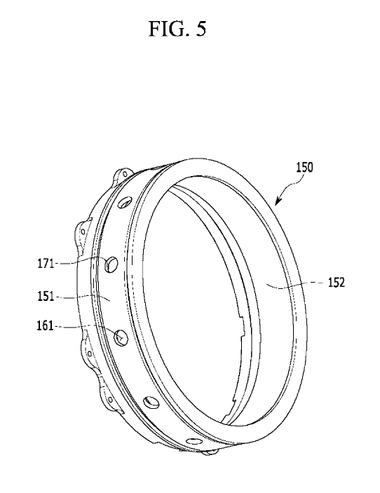

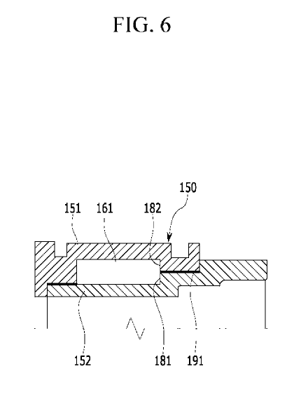

FIG. 5 illustrates a perspective view of the securing member 150, and FIG. 6 illustrates a section of FIG. 5.

Referring to FIGS. 4 to 6, the stator assembly unit 200 includes a securing member 150 having an outer ring 151 for supporting the transmission housing 1 and an inner ring 152 for supporting the stator core 10 of the drive motor 3.

The outer ring 151 supports the inside wall of the transmission housing 1, and the inner ring 152 supports the outside wall of the stator core 10. The outer ring 151 and the inner ring 152 are joined to each other to form a cooling water flow passage 161 between the outer ring 151 and the inner ring 152 formed as one unit therewith for flow of the cooling water.

A joined structure of the outer ring 151 and the inner ring 152 of the securing member 150 and a structure of the cooling water flow passage 161 will be described in more detail later.

In this case, the securing member 150 having the outer ring 151 and the inner ring 152 joined together as one unit has an annular shape overall, and is mounted to the inside wall of the transmission housing 1 through press fitting. The stator core 10 is shrinkage fit to an inside of the securing member 150 to be fixedly secured to the inside circumferential surface of the securing member 150.

In particular, the outside circumferential surface of the outer ring 151 of the securing member 150 is secured to the inside wall of the transmission housing 1 to support the inside wall of the transmission housing 1, and the inside circumferential surface of the inner ring 152 of the securing member 150 is secured to the outside surface of the stator core 10 to support the outside surface of the stator core 10.

The outer ring 151 and the inner ring 152 of the securing member 150 preferably are formed of different materials. As an example, the outer ring 151 may be formed of aluminum, and the inner ring 152 may be formed of carbon steel of a steel group. In this case, the outer ring 151 may be casted by core-type low pressure casting, and the inner ring 152 may be formed by forging and machining.

Thus, in a preferred embodiment of the present invention, the formation of the outer ring 151 and the inner ring 152 of the securing member 150 made of different materials of aluminum and carbon steel permits reduction of weight of the securing member 150 as compared to formation of the securing member 150 entirely of a steel group material.

As described above, the securing member 150 in accordance with a preferred embodiment of the present invention having the outer ring 151 and the inner ring 152 joined to each other may form the cooling water flow passage 161 between the outer ring 151 and the inner ring 152 as one unit therewith for flow of the cooling water therethrough.

In particular, the securing member 150 may have the inner ring 152 and the outer ring 151 joined together at the outside circumferential surface of the inner ring 152 and inside circumferential surface of the outer ring 151 to form the cooling water flow passage 161 between the outer ring 151 and the inner ring 152. The inner ring 152 has at least one first cooling channel 181 formed in the outside circumferential surface thereof, and the outer ring 151 has a second cooling channel 182 formed in the inside circumferential surface thereof corresponding (i.e., matched) to the first cooling channel 181.

The first cooling channel 181 is a groove formed in the outside circumferential surface of the inner ring 152 in a circumferential direction thereof, and the second cooling channel 182 is a groove formed in the inside circumferential surface of the outer ring 151 in a circumferential direction thereof.

Therefore, in the preferred embodiment of the present invention, the cooling water flow passage 161 may be formed in the securing member 150 as the first and second cooling channels 181 and 182 are put together as one unit therewith when the outside circumferential surface of the inner ring 152 and the inside circumferential surface of the outer ring 151 are joined to each other.

With regard to the joining structure of the outer ring 151 and the inner ring 152 of the securing member 150, as joining surfaces of the outer ring 151 and the inner ring 152, the inside circumferential surface of the outer ring 151 and the outside circumferential surface of the inner ring 152 may be fusion welded to each other as one unit.

The inside circumferential surface of the outer ring 151 and the outside circumferential surface of the inner ring 152 may be joined to each other by projection welding.

As an example, in the preferred embodiment of the present invention, projections such as screw threads are formed on one of the inside circumferential surface of the outer ring 151 and the outside circumferential surface of the inner ring 152, and a welding current is applied to the outer ring 151 and the inner ring 152 in a state in which the inside circumferential surface of the outer ring 151 and the outside circumferential surface of the inner ring 152 are brought into close contact with each other, to fusion weld the projections with electrical resistance to join the outer ring 151 and inner ring 152 as one unit.

In the above description, the joined surface of the outer ring 151 and the inner ring 152, i.e., the inside circumferential surface of the outer ring 151 and the outside circumferential surface of the inner ring 152, which are brought into close contact with each other and joined together, form a fusion welded portion 191 by the projection welding.

Since the projection welding is carried out by using a projection welder which is known to one of ordinary skill in the art, a more detailed description thereof will be omitted from this specification.

Accordingly, in the preferred embodiment of the present invention, the securing member 150 is constructed by joining the inside circumferential surface of the outer ring 151 and the outside circumferential surface of the inner ring 152 to each other by projection welding, putting the first cooling channel 181 on a side of the outside circumferential surface of the inner ring 152 and the second cooling channel 182 on a side of the inside circumferential surface of the outer ring 151 together to form the cooling water flow passage 161 in the securing member 150 as one unit with the securing member 150.

In this case, the outer ring 151 of the securing member 150 has a plurality of through holes 171 formed therein and connected to the cooling water flow passage 161. Since the through holes 171 are the same as in the foregoing preferred embodiment in view of configuration and effect, a more detailed description will be omitted hereafter.

According to the stator core assembly unit 200 of a drive motor in a vehicle in accordance with the preferred embodiment of the present invention described up to now, by joining the inside circumferential surface of the outer ring 151 and the outside circumferential surface of the inner ring 152 of different materials to each other, the securing member 150 may be constructed.

Further, in the preferred embodiment of the present invention, the cooling water flow passage 161 may be formed in the securing member 150 with the first cooling channel 181 in the outside circumferential surface of the inner ring 152 and the second cooling channel 182 in the inside circumferential surface of the outer ring 151 as one unit with the securing member 150.

Therefore, in the current preferred embodiment of the present invention, by forming the outer ring 151 and the inner ring 152 of the securing member 150 of different materials (aluminum and a steel group material), weight reduction of the whole assembly structure of the drive motor 3 may be achieved.

Since other configurations and effects of the stator assembly unit 200 of a drive motor of a hybrid vehicle in accordance with the current preferred embodiment of the present invention are identical to the foregoing embodiment, a detailed description thereof will be omitted from the current preferred embodiment of the present invention.

While this invention has been described in connection with what is presently considered to be practical exemplary embodiments, it is to be understood that technical aspects of the present invention are not limited to the exemplary embodiments suggested in the specification, but, although a person of ordinary skill in this field of art who understands the technical aspects of the present invention can suggest other exemplary embodiments by modifications, changes, removal, and/or addition of constituent elements within a range of technical aspects as in the present invention, they may also be within a range of right of the present invention.

What is claimed is:

1. A stator assembly unit of a drive motor of a vehicle, the stator assembly unit having a stator core fixedly mounted to an inside of a housing of a power transmission element in the drive motor of the vehicle, the stator assembly unit comprising:
a securing member mounted to an inside wall of the housing by press fitting for securing the stator core,
wherein the securing member has an annular shape with a flow passage formed in the securing member as one unit to enable flow of a cooling medium.

2. The stator assembly unit of claim 1, wherein the securing member has a plurality of through holes formed in an outside circumferential surface thereof connected to the flow passage.

3. The stator assembly unit of claim 1, wherein the securing member is manufactured by core-type low pressure casting to have the flow passage formed therein as one unit with the securing member.

4. A stator assembly unit of a drive motor of a vehicle, the stator assembly having a stator core fixedly mounted to an inside of a housing of a power transmission element in the drive motor of the vehicle, the stator assembly unit comprising:
a securing member mounted to an inside wall of the housing by press fitting for securing the stator core,
wherein the securing member has an annular shape with an outer ring for supporting the housing and an inner ring for supporting the stator core, and
the inner ring and the outer ring are joined together to form a flow passage between the inner ring and the outer ring to enable flow of a cooling medium.

5. The stator assembly unit of claim 4, wherein the inner ring has at least a first cooling channel formed in the outside circumferential surface thereof, and the outer ring has a second cooling channel formed in the inside circumferential surface thereof corresponding to the first cooling channel,
wherein the cooling water flow passage is formed as the first and second cooling channels are put together at the time the inner ring and the outer ring are joined.

6. The stator assembly unit of claim 5, wherein the outer ring has a plurality of through holes formed therein connected to the flow passage.

7. The stator assembly unit of claim 5, wherein the inner ring and the outer ring are formed of different materials.

8. The stator assembly unit of claim 7, wherein the inner ring is formed of a carbon steel and the outer ring is formed of aluminum.

9. The stator assembly unit of claim 7, wherein the inner ring and the outer ring have joining surfaces thereof that are fusion welded to each other to form one unit.

10. The stator assembly unit of claim 9, wherein the inner ring and the outer ring are joined to each other by projection welding.

11. A stator assembly unit for a hybrid vehicle, comprising:
a stator core fixedly mounted to an inside of a housing of a power transmission element in a drive motor of the hybrid vehicle; and
a securing member mounted to an inside wall of the housing by press fitting for securing the stator core,
wherein the securing member has an annular shape with a flow passage formed in the securing member as one unit to enable flow of a cooling medium.

12. The stator assembly unit of claim 11, wherein the securing member has a plurality of through holes formed in an outside circumferential surface thereof connected to the flow passage.

13. The stator assembly unit of claim 11, wherein the securing member is manufactured by core-type low pressure casting to have the flow passage formed therein as one unit with the securing member.

14. A stator assembly unit for a hybrid vehicle, comprising:
a stator core fixedly mounted to an inside of a housing of a power transmission element in a drive motor of the hybrid vehicle; and
a securing member mounted to an inside wall of the housing by press fitting for securing the stator core,
wherein the securing member has an annular shape with an outer ring for supporting the housing and an inner ring for supporting the stator core, and
the inner ring and the outer ring are joined together to form a flow passage between the inner ring and the outer ring to enable flow of a cooling medium.

15. The stator assembly unit of claim 14, wherein the inner ring has at least a first cooling channel formed in the outside circumferential surface thereof, and the outer ring has a second cooling channel formed in the inside circumferential surface thereof corresponding to the first cooling channel,
wherein the cooling water flow passage is formed as the first and second cooling channels are put together at the time the inner ring and the outer ring are joined.

16. The stator assembly unit of claim 15, wherein the outer ring has a plurality of through holes formed therein connected to the flow passage.

17. The stator assembly unit of claim 15, wherein the inner ring and the outer ring are formed of different materials.

18. The stator assembly unit of claim 17, wherein the inner ring is formed of a carbon steel and the outer ring is formed of aluminum.

19. The stator assembly unit of claim 17, wherein the inner ring and the outer ring have joining surfaces thereof that are fusion welded to each other to form one unit.

20. The stator assembly unit of claim 19, wherein the inner ring and the outer ring are joined to each other by projection welding.
